(19) United States
(12) Patent Application Publication
(10) Pub. No.: US 2011/0280493 A1
(43) Pub. Date: Nov. 17, 2011

(54) VISUAL ENHANCEMENT OF A DATA RECORD

(75) Inventors: Ariel Farkash, Haifa (IL); Ohad Greenshpan, Raanana (IL)

(73) Assignee: International Business Machines Corporation, Armonk, NY (US)

(21) Appl. No.: 12/780,907

(22) Filed: May 16, 2010

(51) Int. Cl. G06K 9/40

(52) U.S. Cl. 382/254

(57) ABSTRACT

A method, system and computer product are provided for visual enhancement of a data record. The method includes selecting a data record including a data field and providing one or more reference data records including the same data field as the selected data record. The method further includes: analysing the data field of the selected data record with reference to the same data field in one or more reference data records according to a defined criterion; determining an annotation of the data field of the selected data record; and applying a visual enhancement corresponding to the annotation to the data field of the selected data record. No additional text data is added to the selected data record.

### BACKGROUND

This invention relates to the field of visual enhancement of a data record. In particular, the invention relates to visual enhancement of a data record based on reference records.

Personal records are characterized by the fact that they carry a historical perspective. In order for users to extract insights from viewing such records, they need to be within historical context. For example, a personal clinical record of a patient undergoing medical treatment, contains a strong link to the subject's medical history, including the type of therapy, therapy length-of-time administration, past reactions, etc. From looking at a single record, one cannot infer trends regarding the health status of the patient.

In a broader context, an observed record may be better interpreted with reference to other records whether of the same subject or different subjects.

In current techniques, information is extracted from a plurality of records and presented summarized in a new document. Alternatively, an original record is supplemented with encumbering additional content.

### BRIEF SUMMARY

According to a first aspect of the present invention there is provided a method for visual enhancement of a data record, comprising: selecting a data record including a data field; providing one or more reference data records including the same data field as the selected data record; analysing the data field of the selected data record with reference to the same data field in one or more reference data records according to a defined criterion; determining an annotation of the data field of the selected data record; applying a visual enhancement corresponding to the annotation to the data field of the selected data record; wherein no additional text data is added to the selected data record; and wherein said steps are implemented in either: computer hardware configured to perform said identifying, tracing, and providing steps, or computer software embodied in a non-transitory, tangible, computer-readable storage medium.

According to a second aspect of the present invention there is provided a computer program product for aggregation of social network data, the computer program product comprising: a computer readable storage medium having computer readable program code embodied therewith, the computer readable program code comprising: computer readable program code configured to: select a data record including a data field; provide one or more reference data records including the same data field as the selected data record; analyse the data field of the selected data record with reference to the same data field in one or more reference data records according to a defined criterion; determine an annotation of the data field of the selected data record; and apply a visual enhancement corresponding to the annotation to the data field of the selected data record; wherein no additional text data is added to the selected data record.

According to a third aspect of the present invention there is provided a system for visual enhancement of a data record, comprising: a processor; a visual enhancement module including: an information analysis component for analysis of a data field of a selected data record with respect to the same data fields in one or more reference records; an annotating component for annotating the data field according to the analysis; a visual enhancement component for translating the annotated field data into a visual enhancement of the data field; and wherein no additional text data is added to the selected data record.

### BRIEF DESCRIPTION OF THE SEVERAL VIEWS OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIG. 1 is a schematic diagram illustrating data records in accordance with the present invention;

FIG. 2A is a block diagram of a first embodiment of a system in accordance with the present invention;

FIG. 2B is a block diagram of a second embodiment of a system in accordance with the present invention;

FIG. 3 is a block diagram of a computer system in which the present invention may be implemented; and

FIG. 4 is a flow diagram of a method in accordance with the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

A method, system and computer program product are described in which valuable information is added on top of a single personal record, with the information extracted from reference records. Visualization techniques are used that do not impose additional text and burden on the user, thus enabling him to understand the comparison at a glance.

Data records take many forms. Interpretation of an observed data record may be improved by comparing a data field of the observed data record with reference records with the same field. In one situation, the reference records may be historical records relating to the same subject with data fields changing over time. In other situations, the reference records may relate to other subjects with the same data field with which comparison is useful.

The described method enhances a viewed record, not through additional encumbering text, but through intuitive emphasis (for example, coloring) of specific elements or data fields being viewed. The described method is applicable to records which are updated over time (for example, clinical records of a patient, school records of a student, banking records, etc.). The described method is also applicable to records of different subjects which can be compared or referenced (for example, a common data field of multiple patients in a clinical trial, a common data field for results of students taking a subject, etc.).

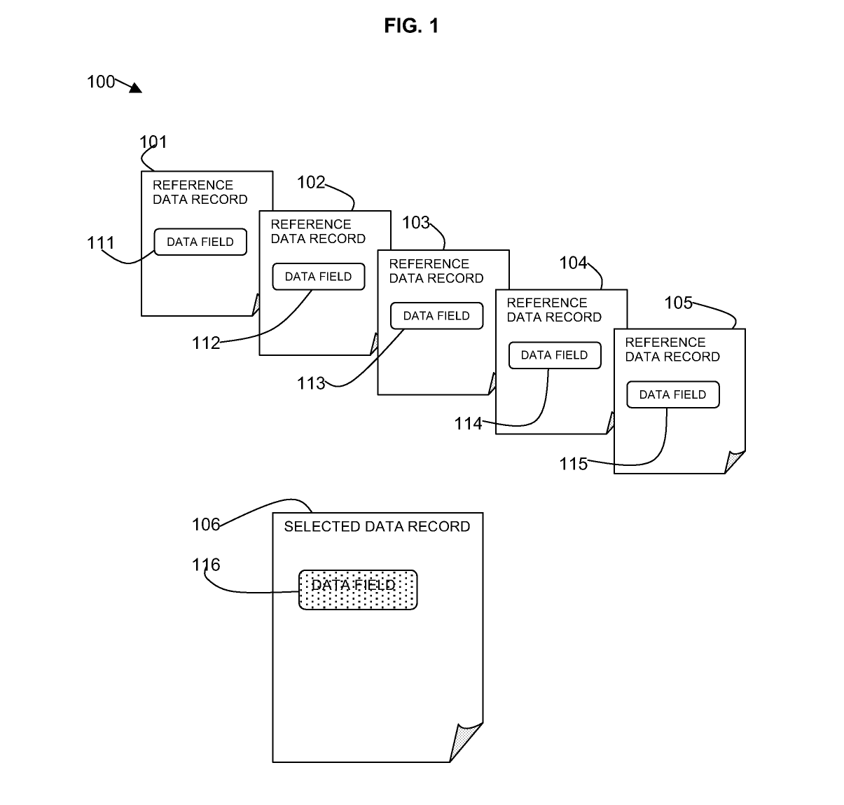

Referring to FIG. 1, a schematic diagram shows a set of records 100 including individual records 101-106 each with a common data field 111-116. The records 101-106 may all relate to a single subject with the data fields 111-116 providing information recorded or applicable at different times. Alternatively, the records 101-106 may relate to different subjects with common data fields 111-116.

An observed record 106 is one of the individual records being viewed by a user. A data field 116 within the observed record 106 is enhanced by analysis of one or more of the data fields 111-115 of the other reference records 101-105.

The following are defined:
The elements to be enhanced in the visualization;
The methods of enhancement in the visualization; and
The meaning of the visualization or the criteria being enhanced.

The following are examples of visual enhancement notations that may be used:
Variations of the font family and type (for example, if text is given in Times New Roman font, special values can be given in Helvetica font type).
Variation of the font size.
Variation of the font style and weight: a) italic, b) bold, c) underline, d) strikethrough.
Variation of the font color.

The enhanced visualization may be implemented in a system various ways. Two embodiments are described.

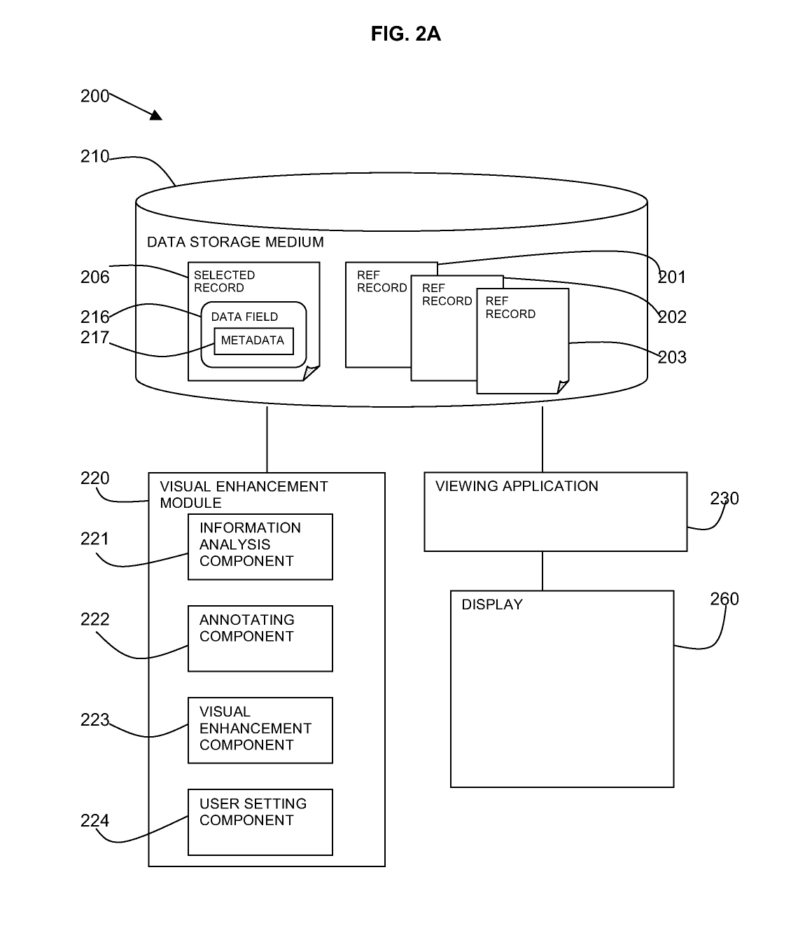

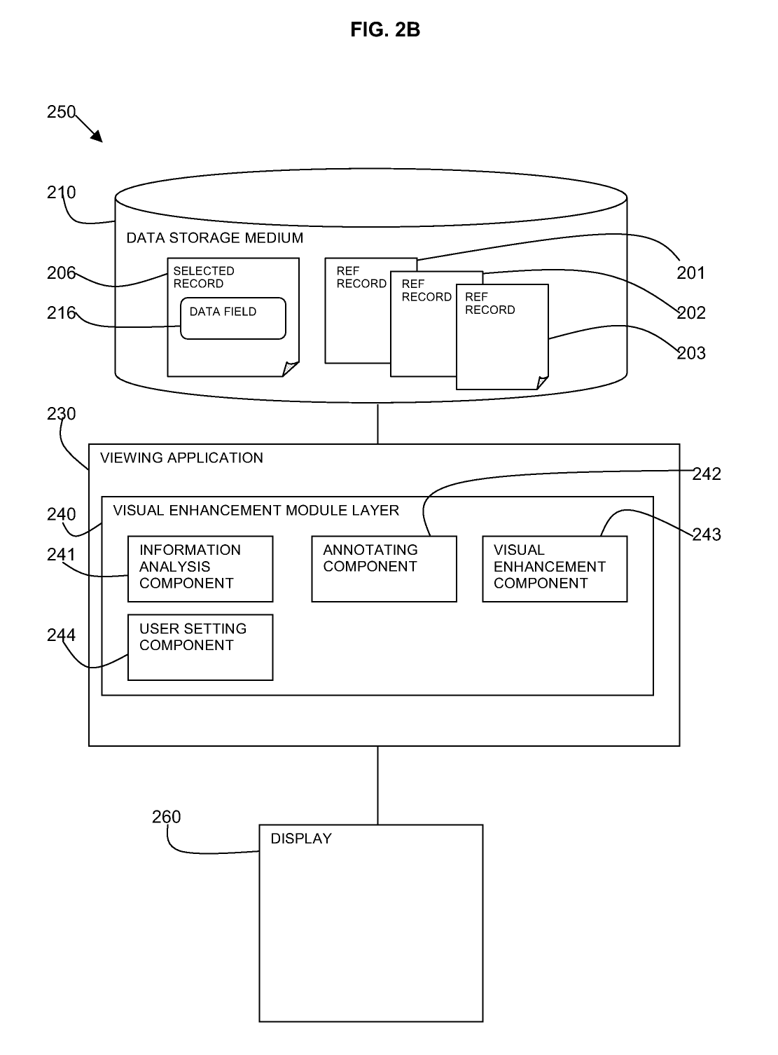

Referring to FIG. 2A, a first embodiment shows a system 200 in which the visualization enhancements are defined as additional metadata in the model of the data record. Thus, the additional visual enhancements (such as color, bold, etc.) are encapsulated as part of the data item/record itself. For example, if the data is represented in XML (eXtensible Markup Language), one may enhance the XML schema.

A system 200 is provided including a data storage medium 210 including multiple records 201, 202, 203, 206. One record 206 is selected as an observed or viewed record with the other records being possible reference records 201-203.

A visual enhancement module 220 is provided including an information analysis component 221 that analyses one or more of the multiple records 201-203 with respect to a selected record to be observed 206.

A datum tagging or annotating component 222 is provided for annotating the data according to the analysis done by the information analysis component 221. An example of such annotation would be: “significantly high value”, “abnormal”, etc.

A visual enhancement component 223 translates the semantic annotation of the annotating component 222 into a visual enhancement. For example, “abnormal” could be translated to the data being coloured green. The visual enhancement component 223 annotates a data field 216 of a data record 206 to provide metadata 217 to show the visual enhancement when the data record 206 is viewed.

A visual enhancement module 220 also includes a user settings module 224 for setting parameters for the data fields to be enhanced, the analysis criteria and annotation, and types and grades of enhancements.

A viewing application 230 is provided by which a user can view a selected record 206 by viewing on a display 260 including viewing the enhancement provided by the metadata 217.

The following example health record of a patient shows how the model metadata is enhanced to encode the visualization. The following record has no enhanced visualization:

<component>

<observation classCode=“OBS” moodCode=“EVN”>
<code code=“8879006” codeSystem=“2.16.840.1.113883.6.96”
codeSystemName=“SNOMED CT” displayName=“Creatinine
measurement, 24 hour urine”/>
<statusCode code=“completed”/>

<effectiveTime>

<width value=“24” unit=“h”/>

</effectiveTime>

<value xsi:type=“PQ” value=“2.1”
unit=“nmol/24hr”/>

</observation>

</component>

The following record shows how this section is enhanced to contain the visualization cues to be used by the viewer showing the data. The enhancement adds the colour green to the value (shown in bold and underlined).

<component>

<observation classCode=“OBS” moodCode=“EVN”>
<code code=“8879006” codeSystem=“2.16.840.1.113883.6.96”
codeSystemName=“SNOMED CT” displayName=“Creatinine
measurement, 24 hour urine”/>
<statusCode code=“completed”/>

<effectiveTime>

<width value=“24” unit=“h”/>

</effectiveTime>

<value xsi:type=“PQ” value=“2.1” unit=“nmol/24hr”
vis:color=“green”/>

</observation>

</component>

Referring to FIG. 2B, a second embodiment shows a system 250 in which the visualization enhancements are defined within a viewing application 230. In one embodiment, the viewing application may be browser based.

The viewing application 230 has a visual enhancement module layer 240 including an information analysis component 241, a datum tagging or annotating component 242, a visual enhancement component 243, and a user setting component 244 as described in relation to FIG. 2A.

The visual enhancement component 243 applies the visual annotation to a selected data record 206 in the viewing application 230 for viewing on a display 260.

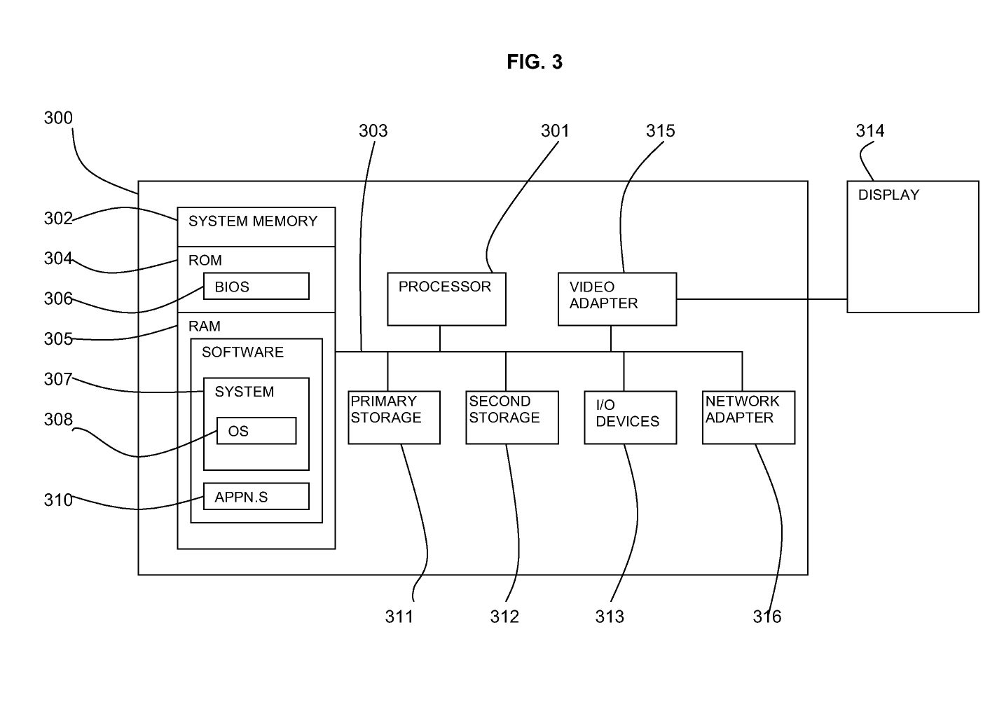

Referring to FIG. 3, an exemplary system for implementing aspects of the invention includes a data processing system 300 suitable for storing and/or executing program code including at least one processor 301 coupled directly or indirectly to memory elements through a bus system 303. The memory elements can include local memory employed during actual execution of the program code, bulk storage, and cache memories which provide temporary storage of at least some program code in order to reduce the number of times code must be retrieved from bulk storage during execution.

The memory elements may include system memory 302 in the form of read only memory (ROM) 304 and random access memory (RAM) 305. A basic input/output system (BIOS) 306 may be stored in ROM 304. System software 307 may be stored in RAM 305 including operating system software 308. Software applications 310 may also be stored in RAM 305.

The system 300 may also include a primary storage means 311 such as a magnetic hard disk drive and secondary storage means 312 such as a magnetic disc drive and an optical disc drive. The drives and their associated computer-readable media provide non-volatile storage of computer-executable instructions, data structures, program modules and other data for the system 300. Software applications may be stored on the primary and secondary storage means 311, 312 as well as the system memory 302.

The computing system 300 may operate in a networked environment using logical connections to one or more remote computers via a network adapter 316.

Input/output devices 313 can be coupled to the system either directly or through intervening I/O controllers. A user may enter commands and information into the system 300 through input devices such as a keyboard, pointing device, or other input devices (for example, microphone, joy stick, game pad, satellite dish, scanner, or the like). Output devices may include speakers, printers, etc. A display device 314 is also connected to system bus 303 via an interface, such as video adapter 315.

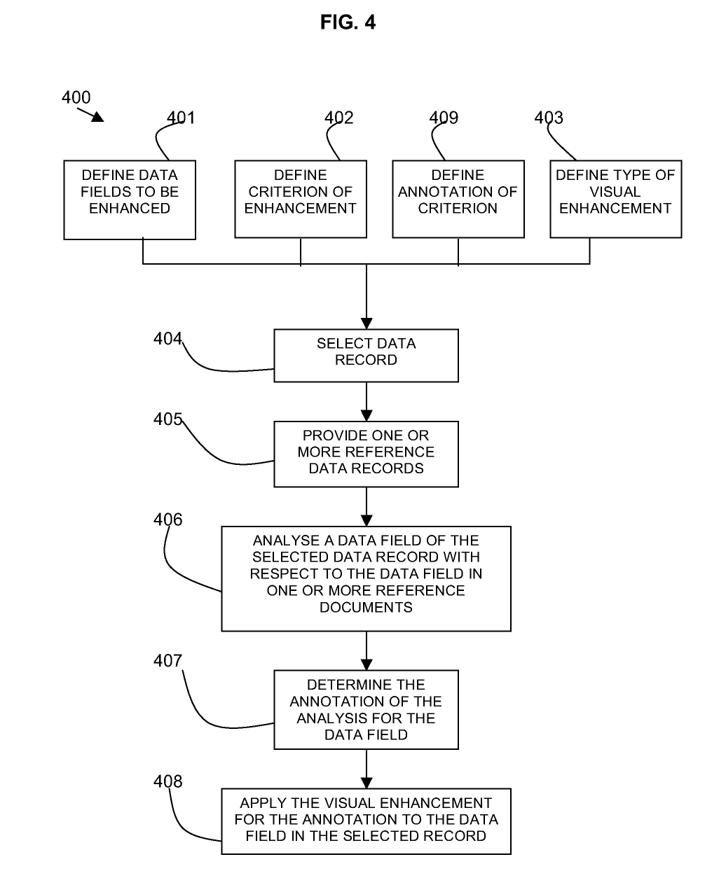

Referring to FIG. 4, a flow diagram 400 shows the described method of visual enhancement of a selected data record.

Parameters are defined for the visual enhancement including data fields to be enhanced 401, the meaning or criterion of the analysis 402, the annotations of the criterion 409, and the types of visual enhancement 403.

For example, all data fields may be defined to be enhanced with a criterion of a temporal gradient of value change, with defined annotations of significant decrease, slight decrease, constant, slight increase, significant increase, and with defined enhancements of colours for each annotation.

A record is selected 404 to be observed or viewed and one or more reference records are provided 405. A data field of the selected record is analysed 406 with respect to the corresponding data field in one or more reference documents. The annotation of the analysis is determined 407 for the data field and the corresponding visual enhancement for the annotation is applied 408 to the data field in the selected record.

In one embodiment, the above steps of the flow diagram 400 may be carried out in a system component and the resultant visual enhancement added to the metadata model of a stored record which will be interpreted when the record is viewed.

Alternatively, the above steps of the flow diagram 400 are carried out in an additional layer of a viewing application to analyse and enhance a viewed record.

In order to describe the visual enhancement of a selected data record further, an example is used of a patient's reaction-to-therapy, taken from the clinical domain. In the example, a person is undergoing treatment for hypertension. The example shows how the historical context regarding the patient's reaction to therapy is easily viewed when observing a selected record with the described visual enhancements.

The stored historical records for the patient are shown in the table below, Table 1. This gives the context of the whole longitudinal clinical history of the patient.

TABLE 1

| TEST | | DATE OF TESTS | | | |
|---|---|---|---|---|---|
| NAMES | Units | 4/1/2007 | 15/6/2007 | 4/2/2008 | 24/12/2008 |
| SERUM | | | | | |
| PROTEIN | | | | | |
| ELECTRO- | | | | | |
| PHORESIS | | | | | |
| Calcium, | mmol/L | 2.513 | 2.518 | 2.521 | 2.514 |
| Serum | | | | | |
| Chlorine, | mmol/L | 103 | 101 | 103 | 102 |
| Serum | | | | | |
| Creatinine, | mmol/L | 82.32 | 101.54 | 90.25 | 105.32 |
| Serum | | | | | |
| Glucose, | mmol/L | 4.22 | 4.26 | 5.08 | 3.98 |
| Serum | | | | | |
| Insulin, | mmol/L | 10.3 | 10.1 | 10.2 | 10.3 |
| Serum | | | | | |
| Magnesium, | mmol/L | 0.93 | 0.85 | 0.96 | 0.91 |
| Serum | | | | | |
| Potassium, | mmol/L | 3.68 | 3.95 | 4.02 | 4.05 |
| Serum | | | | | |
| Sodium, | mmol/L | 140.1 | 138.5 | 137.2 | 135.4 |
| Serum | | | | | |
| URINE | | | | | |
| PROTEIN | | | | | |
| ELECTRO- | | | | | |
| PHORESIS | | | | | |
| Aldosterone, | nmol/24 hr | 33.4 | 45.3 | 37.6 | 40.2 |
| Urine 24 h | | | | | |
| Calcium, | nmol/24 hr | 10.54 | 9.51 | 1.25 | 0.32 |
| Urine 24 h | | | | | |
| Creatinine, | nmol/24 hr | 17.3 | 15.2 | 2.1 | 1.5 |
| Urine 24 h | | | | | |
| Magnesium, | nmol/24 hr | 5.06 | 5.03 | 4.92 | |
| Urine 24 h | | | | | |
| Potassium, | nmol/24 hr | 220.3 | 200.5 | 42.4 | 35.6 |
| Urine 24 h | | | | | |
| Albumin, | % | 98 | 98 | | 97 |
| Urine | | | | | |
| Protein, | mg/24 hr | 344 | 321 | 140 | 113 |
| Urine 24 h | | | | | |

The current observed patient's record may be one of the dated records, for example the record of date 4 Feb. 2008 shown in Table 2.

TABLE 2

| | | DATE |
|---|---|---|
| | | OF TEST |
| TEST NAMES | Units | Apr. 2, 2008 |
| SERUM PROTEIN | | |
| ELECTROPHORESIS | | |
| Calcium, Serum | mmol/L | 2.521 |
| Chlorine, Serum | mmol/L | 103 |
| Creatinine, Serum | mmol/L | 90.25 |
| Glucose, Serum | mmol/L | 5.08 |
| Insulin, Serum | mmol/L | 10.2 |
| Magnesium, Serum | mmol/L | 0.96 |
| Potassium, Serum | mmol/L | 4.02 |
| Sodium, Serum | mmol/L | 137.2 |
| URINE PROTEIN | | |
| ELECTROPHORESIS | | |
| Aldosterone, Urine 24 h | nmol/24 hr | 37.6 |
| Calcium, Urine 24 h | nmol/24 hr | 1.25 |
| Creatinine, Urine 24 h | nmol/24 hr | 2.1 |
| Magnesium, Urine 24 h | nmol/24 hr | 4.92 |
| Potassium, Urine 24 h | nmol/24 hr | 42.4 |
| Albumin, Urine | % | |
| Protein, Urine 24 h | mg/24 hr | 140 |

A user is able to select the criteria for visual notations. The criteria in this example include the following:
With regards to the patient's temporal gradient of change.
Variability of values.
Reaction to therapy.
With regards to the patient's normal health status.

### Example Criterion 1

### With Regard to the Patient's Temporal Gradient of Value Change

The following notations and visual enhancements are used:
Dark Green—Significant decrease;
Light Green—Slight decrease;
Black—Remained constant;
Orange—Slight increase;
Red—Significant increase.

This view shown below in Table 3 contains a snapshot of longitudinal information, i.e. context of clinical history of patient. Table 3 shows an observed record of date 15 Jun. 2007 enhanced with the value change compared to the previous temporal record of 4 Jan. 2007. The colours that the figures would be displayed in are written in brackets.

TABLE 3

| | | DATE OF |
|---|---|---|
| | | TEST |
| TEST NAMES | Units | 15/6/2007 |
| SERUM PROTEIN | | |
| ELECTROPHORESIS | | |
| Calcium, Serum | mmol/L | 2.518 |
| Chlorine, Serum | mmol/L | 101 |
| Creatinine, Serum | mmol/L | 101.54 |
| | | [orange] |
| Glucose, Serum | mmol/L | 4.26 |
| Insulin, Serum | mmol/L | 10.1 |
| Magnesium, Serum | mmol/L | 0.85 |
| | | [light green] |
| Potassium, Serum | mmol/L | 3.95 |
| Sodium, Serum | mmol/L | 138.5 |
| | | [light green] |
| URINE PROTEIN | | |
| ELECTROPHORESIS | | |
| Aldosterone, Urine 24 h | nmol/24 hr | 45.3 |
| | | [red] |
| Calcium, Urine 24 h | nmol/24 hr | 9.51 |
| | | [light green] |
| Creatinine, Urine 24 h | nmol/24 hr | 15.2 |
| | | [light green] |
| Magnesium, Urine 24 h | nmol/24 hr | 5.03 |
| Potassium, Urine 24 h | nmol/24 hr | 200.5 |
| | | [light green] |
| Albumin, Urine | % | 98 |
| Protein, Urine 24 h | mg/24 hr | 321 |
| | | [dark green] |

### Example Criterion 2

### Variability of Values

The following notations and visual enhancements are used:
Variability resolution is marked by “bold italics”

Table 4 shows the observed record of date 15 Jun. 2007 is shown with the variability of values compared to the previous record of 4 Jan. 2007.

Here one can see the variable with resolution that may be the full datum or a partial datum. Thus if the values are all in 420-428 range, only the final digit is enhanced with bold italics: 422, 428, 426, 423

TABLE 4

| | | DATE |
|---|---|---|
| | | OF TEST |
| TEST NAMES | Units | 15/6/2007 |
| SERUM PROTEIN | | |
| ELECTROPHORESIS | | |
| Calcium, Serum | mmol/L | 2.518 |
| Chlorine, Serum | mmol/L | 101 |
| Creatinine, Serum | mmol/L | 101.54 |
| Glucose, Serum | mmol/L | 4.26 |
| Insulin, Serum | mmol/L | 10.1 |
| Magnesium, Serum | mmol/L | 0.85 |
| Potassium, Serum | mmol/L | 3.95 |
| Sodium, Serum | mmol/L | 138.5 |
| URINE PROTEIN | | |
| ELECTROPHORESIS | | |
| Aldosterone, Urine 24 h | nmol/24 hr | 45.3 |
| Calcium, Urine 24 h | nmol/24 hr | 9.51 |
| Creatinine, Urine 24 h | nmol/24 hr | 15.2 |
| Magnesium, Urine 24 h | nmol/24 hr | 5.03 |
| Potassium, Urine 24 h | nmol/24 hr | 200.5 |
| Albumin, Urine | % | 98 |
| Protein, Urine 24 h | mg/24 hr | 321 |

### Example Criterion 3

### Reaction to Therapy

The following notations and visual enhancements are used:
Relevance to reaction is marked by “bold”
Black—value was “normal” and remained “normal”
Green—value was “abnormal” and became “normal”
Orange—value was “normal” and became “abnormal”
Red—value was “abnormal” and remained “abnormal”

This view shown below in Table 5 shows an observed record of date 4 Feb. 2008 enhanced with the value change compared to the previous temporal record of 15 Jun. 2007. The colours that the figures would be displayed in are written in brackets.

Here one can see a significant improvement in the parameters relevant for the disease under inspection (marked in bold).

TABLE 5

| | | DATE OF |
|---|---|---|
| | | TEST |
| TEST NAMES | Units | Apr. 2, 2008 |
| SERUM PROTEIN | | |
| ELECTROPHORESIS | | |
| Calcium, Serum | mmol/L | 2.521 |
| Chlorine, Serum | mmol/L | 103 |
| Creatinine, Serum | mmol/L | 90.25 |
| Glucose, Serum | mmol/L | 5.08 |
| | | [orange] |
| Insulin, Serum | mmol/L | 10.2 |
| Magnesium, Serum | mmol/L | 0.96 |
| Potassium, Serum | mmol/L | 4.02 |
| Sodium, Serum | mmol/L | 137.2 |
| URINE PROTEIN | | |
| ELECTROPHORESIS | | |
| Aldosterone, Urine 24 h | nmol/24 hr | 37.6 |
| Calcium, Urine 24 h | nmol/24 hr | 1.25 |
| | | [green] |
| Creatinine, Urine 24 h | nmol/24 hr | 2.1 |
| | | [green] |
| Magnesium, Urine 24 h | nmol/24 hr | 4.92 |
| Potassium, Urine 24 h | nmol/24 hr | 42.4 |
| | | [green] |
| Albumin, Urine | % | |
| Protein, Urine 24 h | mg/24 hr | 140 |
| | | [green] |

### Example Criterion 4

### With Regards to the Patient's Normal Health Status

The following notations and visual enhancements are used:
Green—Normal
Red—Abnormal

This view shown below in Table 6 shows an observed record of date 15 Jun. 2007 enhanced with regard to the patient's normal health status. The colours that the figures would be displayed in are written in brackets.

TABLE 6

| | | DATE |
|---|---|---|
| | | OF TEST |
| TEST NAMES | Units | 15/6/2007 |
| SERUM PROTEIN | | |
| ELECTROPHORESIS | | |
| Calcium, Serum | mmol/L | 2.518 |
| | | [green] |
| Chlorine, Serum | mmol/L | 101 |
| | | [green] |
| Creatinine, Serum | mmol/L | 101.54 |
| | | [green] |
| Glucose, Serum | mmol/L | 4.26 |
| | | [green] |
| Insulin, Serum | mmol/L | 10.1 |
| | | [green] |
| Magnesium, Serum | mmol/L | 0.85 |
| | | [green] |
| Potassium, Serum | mmol/L | 3.95 |
| | | [green] |
| Sodium, Serum | mmol/L | 138.5 |
| | | [green] |
| URINE PROTEIN | | |
| ELECTROPHORESIS | | |
| Aldosterone, Urine 24 h | nmol/24 hr | 45.3 |
| | | [green] |
| Calcium, Urine 24 h | nmol/24 hr | 9.51 |
| | | [red] |
| Creatinine, Urine 24 h | nmol/24 hr | 15.2 |
| | | [red] |
| Magnesium, Urine 24 h | nmol/24 hr | 5.03 |
| | | [green] |
| Potassium, Urine 24 h | nmol/24 hr | 200.5 |
| | | [red] |
| Albumin, Urine | % | 98 |
| | | [green] |
| Protein, Urine 24 h | mg/24 hr | 321 |
| | | [red] |

The comparison with the patient's normal health status may be obtained by the following methods.

Routine checkups that were determined by the physician to be representative of a healthy status. These can serve as a reference for later checkups when a patient is undergoing treatment. This is a routine process before patients start treatment. Example: A patient has nail fungus. The physician recommends taking systematic treatment that may affect liver functionality. The patient then undergoes a blood test before starting treatment, which is used a reference for tests performed during treatment.

This can be calculated automatically, based on patient history (for example, last few years, or all history), discarding abnormal values (for example, by determining significant variations from majority, or averaging on long periods).

The historical records used to provide the visualization enhancement may be a single earlier record, or a longer historical context. For example, average of last five visits, average of last two years, etc.

The described visualization enhancement aims to enhance a visual interface for viewing records, for example, with their historical context or reference context, while adhering to the original record's content in order to minimize the burden on the user.

Data from an observed record is enhanced by reference records without imposing additional textual information on the user.

A visualization enhancement system may be provided as a service to a customer over a network.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for visual enhancement of a data record, comprising:
selecting a data record including a data field;
providing one or more reference data records including the same data field as the selected data record;
analysing the data field of the selected data record with reference to the same data field in one or more reference data records according to a defined criterion;
determining an annotation of the data field of the selected data record;
applying a visual enhancement corresponding to the annotation to the data field of the selected data record;
wherein no additional text data is added to the selected data record; and
wherein said steps are implemented in either:
computer hardware configured to perform said identifying, tracing, and providing steps, or
computer software embodied in a non-transitory, tangible, computer-readable storage medium.

2. The method as claimed in claim 1, including:
defining annotations for a data field; and
defining visual enhancements corresponding to the annotations.

3. The method as claimed in claim 1, wherein the selected data record and the reference data records relate to the same subject at different times.

4. The method as claimed in claim 1, wherein the defined annotations for a data field include one or more of the group of: value increase or decrease variations, normal or abnormal variations, relative values to other records.

5. The method as claimed in claim 1, wherein the defined visual enhancements corresponding to the annotations include one or more of the group of: variations of font, variations of size, variations of style, and variations of colour.

6. The method as claimed in claim 1, wherein the visual enhancement of a data field is applied by adding the visual enhancement to a metadata model of the selected data record and interpreting the visual enhancement during viewing of the selected data record.

7. The method as claimed in claim 1, wherein the steps of analysing the data field, determining the annotation and applying the visual enhancement of a data field are carried out in a viewing application for viewing a selected data record.

8. A computer program product for aggregation of social network data, the computer program product comprising:
a computer readable storage medium having computer readable program code embodied therewith, the computer readable program code comprising:
computer readable program code configured to:
select a data record including a data field;
provide one or more reference data records including the same data field as the selected data record;
analyse the data field of the selected data record with reference to the same data field in one or more reference data records according to a defined criterion;
determine an annotation of the data field of the selected data record; and
apply a visual enhancement corresponding to the annotation to the data field of the selected data record;
wherein no additional text data is added to the selected data record.

9. The computer program product as claimed in claim 8, including computer readable program code configured to:
define annotations for a data field; and
define visual enhancements corresponding to the annotations.

10. The computer program product as claimed in claim 8, wherein the selected data record and the reference data records relate to the same subject at different times.

11. The computer program product as claimed in claim 8, wherein the defined annotations for a data field include one or more of the group of: value increase or decrease variations, normal or abnormal variations, relative values to other records.

12. The computer program product as claimed in claim 8, wherein the defined visual enhancements corresponding to the annotations include one or more of the group of: variations of font, variations of size, variations of style, and variations of colour.

13. The computer program product as claimed in claim 8, wherein the visual enhancement of a data field is applied by adding the visual enhancement to a metadata model of the selected data record and interpreting the visual enhancement during viewing of the selected data record.

14. The computer program product as claimed in claim 8, wherein the steps of analysing the data field, determining the annotation and applying the visual enhancement of a data field are carried out in a viewing application for viewing a selected data record.

15. A system for visual enhancement of a data record, comprising:
a processor;
a visual enhancement module including:
an information analysis component for analysis of a data field of a selected data record with respect to the same data fields in one or more reference records;
an annotating component for annotating the data field according to the analysis;
a visual enhancement component for translating the annotated field data into a visual enhancement of the data field; and
wherein no additional text data is added to the selected data record.

16. The system as claimed in claim 15, wherein the visual enhancement module adds metadata relating to the visual enhancement of a data field to a metadata model of the selected record for interpretation during viewing of the selected data record.

17. The system as claimed in claim 15, wherein the visual enhancement module is a layer of a viewing application and the visual enhancement of a data field is applied in a viewing application for a selected data record.

18. The system as claimed in claim 15, including: a user setting component for:
defining annotations for a data field; and
defining visual enhancements corresponding to the annotations.

19. The system as claimed in claim 15, wherein the selected data record and the reference data records relate to the same subject at different times.

20. The system as claimed in claim 15, wherein the defined annotations for a data field include one or more of the group of: value increase or decrease variations, normal or abnormal variations, relative values to other records.

21. The system as claimed in claim 15, wherein the visual enhancements corresponding to the annotations include one or more of the group of: variations of font, variations of size, variations of style, and variations of colour.
